(19) United States
(12) Patent Application Publication
(10) Pub. No.: US 2020/0334477 A1
(43) Pub. Date: Oct. 22, 2020

(54) STATE ESTIMATION APPARATUS, STATE ESTIMATION METHOD, AND STATE ESTIMATION PROGRAM

(71) Applicant: OMRON Corporation, Kyoto-shi, KYOTO (JP)

(72) Inventors: Hatsumi AOI, Kyotanabe-shi (JP); Koichi KINOSHITA, Kyoto-shi (JP); Tomoyoshi AIZAWA, Kyoto-shi (JP); Hideto HAMABASHIRI, Moriyama-shi (JP); Tadashi HYUGA, Hirakata-shi (JP); Mei UETANI, Uji-shi (JP)

(73) Assignee: OMRON Corporation, Kyoto-shi, KYOTO (JP)

(21) Appl. No.: 16/303,710

(22) PCT Filed: Jun. 1, 2017
(86) PCT No.: PCT/JP2017/020378

§ 371 Date: Nov. 21, 2018

(30) Foreign Application Priority Data
Jun. 2, 2016 (JP) 2016-111108
Feb. 24, 2017 (JP) PCT/JP2017/007142

(51) Int. Cl. G06K 9/00; B60W 40/09

(52) U.S. Cl. CPC G06K 9/00845; B60W 40/09; B60W 2540/229; B60W 2540/22; B60W 2540/221; G06K 9/00302

(57) ABSTRACT

A state estimation apparatus includes an image obtaining unit that obtains a captured image from an imaging device placed to capture an image of a target person to be at a predetermined position, a first analysis unit that analyzes a facial behavior of the target person based on the captured image and obtains first information about the facial behavior of the target person, a second analysis unit that analyzes body movement of the target person based on the captured image and obtains second information about the body movement of the target person, and an estimation unit that estimates a state of the target person based on the first information and the second information.

### FIELD

The present invention relates to a state estimation apparatus, a state estimation method, and a state estimation program.

### BACKGROUND

Apparatuses for preventing serious accidents have been developed recently to estimate the state of a vehicle driver, such as falling asleep while driving, distracted driving, or a sudden change in his or her physical conditions, by capturing an image of the driver and processing the image. For example, Patent Literature 1 describes a concentration determination apparatus that detects the gaze of a vehicle driver and determines that the driver concentrates less on driving when the detected gaze remains unchanged for a long time. Patent Literature 2 describes an image analysis apparatus that determines the degree of drowsiness felt by a vehicle driver and the degree of distracted driving by comparing the face image on the driver's license with an image of the driver captured during driving. Patent Literature 3 describes a drowsiness detection apparatus that detects movement of a driver's eyelids and determine drowsiness felt by the driver by detecting any change in the face angle of the driver immediately after detecting the movement to prevent the driver looking downward from being erroneously determined as feeling drowsy. Patent Literature 4 describes a drowsiness determination apparatus that determines the level of drowsiness felt by a driver based on muscle movement around his or her mouth. Patent Literature 5 describes a face state determination apparatus that detects the face of a driver in a reduced image obtained by resizing a captured image of the driver and extracts specific parts of the face (the eyes, the nose, the mouth) to determine the state of the driver such as falling asleep based on movement of the specific parts. Patent Literature 6 describes an image processing apparatus that cyclically performs multiple processes in sequence, including determining the driver's face orientation and estimating the gaze.

### CITATION LIST

### Patent Literature

Patent Literature 1: Japanese Unexamined Patent Application Publication No. 2014-191474

Patent Literature 2: Japanese Unexamined Patent Application Publication No. 2012-084068

Patent Literature 3: Japanese Unexamined Patent Application Publication No. 2011-048531

Patent Literature 4: Japanese Unexamined Patent Application Publication No. 2010-122897

Patent Literature 5: Japanese Unexamined Patent Application Publication No. 2008-171108

Patent Literature 6: Japanese Unexamined Patent Application Publication No. 2008-282153

### SUMMARY

### Technical Problem

The inventors have noticed difficulties with the above techniques for estimating the state of a driver. More specifically, the above techniques simply use specific changes in the driver's face, such as a change in face orientation, eye opening or closing, and a gaze shift, to estimate the state of a driver. Such techniques may erroneously determine the driver's usual actions, such as turning the head right and left to check the surroundings when the vehicle turns right or left, looking back for a check, and shifting the gaze to check the displays on a mirror, a meter, and an on-vehicle device, to be the driver's looking aside or concentrating less on driving. The techniques may also erroneously determine a driver not concentrating on driving, such as eating and drinking, smoking, or talking on a mobile phone while looking forward, to be in a normal state. These known techniques simply use information obtained from specific changes in the driver's face, and thus may not reflect various possible states of the driver, and thus may not accurately estimate the degree of the driver's concentration on driving. Such difficulties noticed by the inventors are commonly seen in estimating the state of a target person other than a driver, such as a factory worker.

One or more aspects of the present invention are directed to a technique that appropriately estimates various possible states of a target person.

### Solution to Problem

A state estimation apparatus according to one aspect of the present invention includes an image obtaining unit that obtains a captured image from an imaging device placed to capture an image of a target person to be at a predetermined position, a first analysis unit that analyzes a facial behavior of the target person based on the captured image and obtains first information about the facial behavior of the target person, a second analysis unit that analyzes body movement of the target person based on the captured image and obtains second information about the body movement of the target person, and an estimation unit that estimates a state of the target person based on the first information and the second information.

The state estimation apparatus with this structure obtains the first information about the facial behavior of the target person and the second information about the body movement, and estimates the state of the target person based on the obtained first information and second information. The state analysis of the target person thus uses overall information about the body movement of the target person, in addition to local information about the facial behavior of the target person. The apparatus with this structure thus estimates various possible states of the target person.

In the state estimation apparatus according to the above aspect, the first information and the second information may be each represented as one or more feature quantities, and the estimation unit may estimate the state of the target person based on the feature quantities. This structure uses the information represented by feature quantities to facilitate computation for estimating various possible states of the target person.

The state estimation apparatus according to the above aspect may further include a weighting unit that determines, for each of the feature quantities, a weight defining a priority among the feature quantities. The estimation unit may estimate the state of the target person based on each feature quantity weighted using the determined weight. The apparatus with this structure appropriately weights the feature quantities to improve the accuracy in estimating the state of the target person.

In the state estimation apparatus according to the above aspect, the weighting unit may determine the weight for each feature quantity based on a past estimation result of the state of the target person. The apparatus with this structure uses the past estimation result to improve the accuracy in estimating the state of the target person. To determine, for example, that the target person is looking back, the next action likely to be taken by the target person is looking front. In this case, the feature quantities associated with looking front may be weighted more than the other feature quantities to improve the accuracy in estimating the state of the target person.

The state estimation apparatus according to the above aspect may further include a resolution conversion unit that lowers a resolution of the captured image. The second analysis unit may obtain the second information by analyzing the body movement in the captured image with a lower resolution. A captured image may include the body movement behavior appearing greater than the facial behavior.

Thus, the second information about the body movement may be obtained from a captured image having less information or a lower resolution than the captured image used for obtaining the first information about the facial behavior. The apparatus with this structure thus uses the captured image with a lower resolution to obtain the second information. This structure reduces the computation for obtaining the second information and the load on the processor for estimating the state of the target person.

In the state estimation apparatus according to the above aspect, the second analysis unit may obtain, as the second information, a feature quantity associated with at least one item selected from the group consisting of an edge position, an edge strength, and a local frequency component extracted from the captured image with a lower resolution. The apparatus with this structure obtains the second information about the body movement in an appropriate manner from the captured image with a lower resolution, and thus can estimate the state of the target person accurately.

In the state estimation apparatus according to the above aspect, the captured image may include a plurality of frames, and the second analysis unit may obtain the second information by analyzing the body movement in two or more frames included in the captured image. The apparatus with this structure extracts the body movement across two or more frames, and thus can estimate the state of the target person accurately.

In the state estimation apparatus according to the above aspect, the first analysis unit may perform predetermined image analysis of the captured image to obtain, as the first information, information about at least one item selected from the group consisting of whether a face is detected, a face position, a face orientation, a face movement, a gaze direction, a facial component position, and eye opening or closing of the target person. The apparatus with this structure obtains the first information about the facial behavior in an appropriate manner, and thus can estimate the state of the target person accurately.

In the state estimation apparatus according to the above aspect, the captured image may include a plurality of frames, and the first analysis unit may obtain the first information by analyzing the facial behavior in the captured image on a frame basis. The apparatus with this structure obtains the first information on a frame basis to detect a slight change in the facial behavior, and can thus estimate the state of the target person accurately.

In the state estimation apparatus according to the above aspect, the target person may be a driver of a vehicle, the image obtaining unit may obtain the captured image from the imaging device placed to capture an image of the driver in a driver's seat of the vehicle, and the estimation unit may estimate a state of the driver based on the first information and the second information. The estimation unit may estimate at least one state of the driver selected from the group consisting of looking forward carefully, feeling drowsy, looking aside, putting on or taking off clothes, operating a phone, leaning, being interrupted in driving by a passenger or a pet, suffering a disease attack, looking back, resting a head on arms, eating and drinking, smoking, feeling dizzy, taking abnormal movement, operating a car navigation system or an audio system, putting on or taking off glasses or sunglasses, and taking a photograph. The state estimation apparatus with this structure can estimate various states of the driver.

In the state estimation apparatus with this structure, the target person may be a factory worker. The image obtaining unit may obtain the captured image from the imaging device placed to capture an image of the worker to be at a predetermined work site. The estimation unit may estimate a state of the worker based on the first information and the second information. The estimation unit may estimate, as the state of the worker, a degree of concentration of the worker on an operation or a health condition of the worker. The state estimation apparatus with this structure can estimate various states of the worker. The health condition of the worker may be represented by any health indicator, such as an indicator of physical conditions or fatigue.

Another form of the state estimation apparatus according to the above aspects may be an information processing method for implementing the above features, an information processing program, or a storage medium storing the program readable by a computer or another apparatus or machine. The computer-readable recording medium includes a medium storing a program or other information in an electrical, magnetic, optical, mechanical, or chemical manner.

A state estimation method according to one aspect of the present invention is implemented by a computer. The method includes obtaining a captured image from an imaging device placed to capture an image of a target person to be at a predetermined position, analyzing a facial behavior of the target person based on the captured image, obtaining first information about the facial behavior of the target person by analyzing the facial behavior, analyzing body movement of the target person based on the captured image, obtaining second information about the body movement of the target person by analyzing the body movement, and estimating a state of the target person based on the first information and the second information.

A state estimation program according to one aspect of the present invention causes a computer to implement obtaining a captured image from an imaging device placed to capture an image of a target person to be at a predetermined position, analyzing a facial behavior of the target person based on the captured image, obtaining first information about the facial behavior of the target person by analyzing the facial behavior, analyzing body movement of the target person based on the captured image, obtaining second information about the body movement of the target person by analyzing the body movement, and estimating a state of the target person based on the first information and the second information.

### Advantageous Effects

The apparatus, the method, and the program according to these aspects of the present invention enable various possible states of a target person to be estimated appropriately.

### BRIEF DESCRIPTION OF THE DRAWINGS

FIG. 1 is a schematic diagram of a state estimation apparatus according to an embodiment used in one situation.

FIG. 2 is a schematic diagram of the state estimation apparatus according to the embodiment showing its hardware configuration.

FIG. 3A is a schematic diagram of the state estimation apparatus according to the embodiment showing its functional components.

FIG. 3B is a schematic diagram of a facial component state detector showing its functional components.

FIG. 4 is a table showing example combinations of states of a driver and information used to estimate the states.

FIG. 5 is a table showing specific conditions for estimating the state of a driver.

FIG. 6 is a flowchart of a procedure performed by the state estimation apparatus according to the embodiment.

FIG. 7 is a diagram describing a method for detecting a driver's face orientation, the gaze direction, and the degree of eye opening on a multiple-degree scale.

FIG. 8 is a diagram describing a process for extracting feature quantities about body movement of a driver.

FIG. 9 is a diagram describing a process for calculating each feature quantity.

FIG. 10 is a diagram describing a process for estimating the state of a driver based on each feature quantity and a process for changing the weight on each feature quantity in accordance with the estimation result.

FIG. 11 is a diagram describing weighting that follows determined looking back by a driver.

FIG. 12 is a table showing example feature quantities (time-series information) detected when a driver rests the head on the arms.

FIG. 13 is a table showing example feature quantities (time-series information) detected when a driver distracted by an object on the right gradually lowers his or her concentration.

FIG. 14 is a diagram describing a state estimation method for a target person according to another embodiment.

FIG. 15 is a block diagram of a state estimation apparatus according to still another embodiment.

FIG. 16 is a block diagram of a state estimation apparatus according to still another embodiment.

FIG. 17 is a schematic diagram of a state estimation apparatus according to still another embodiment used in one situation.

### DETAILED DESCRIPTION

One or more embodiments of the present invention (hereafter, the present embodiment) will now be described with reference to the drawings. The present embodiment described below is a mere example in any aspect, and may be variously modified or altered without departing from the scope of the invention. More specifically, any configuration specific to each embodiment may be used as appropriate to implement the embodiments of the present invention. Although data used in the present embodiment is described in a natural language, such data may be specifically defined using any computer-readable language, such as a pseudo language, commands, parameters, or a machine language.

### 1. Example Use

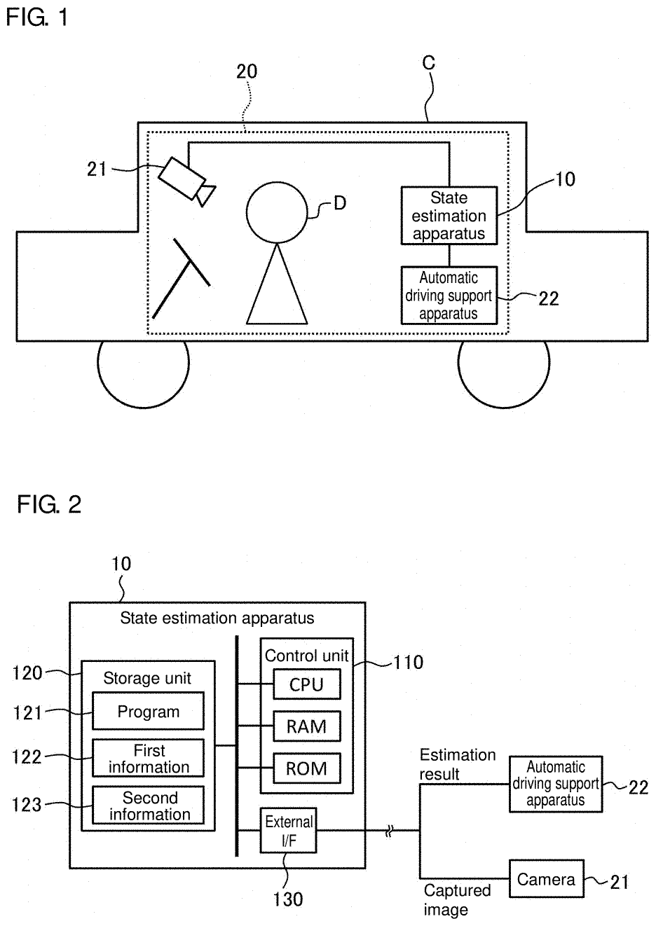

One example use of a state estimation apparatus according to one embodiment of the present invention will now be described with reference to FIG. 1. FIG. 1 is a schematic diagram of a state estimation apparatus 10 according to the embodiment used in an automatic driving system 20.

As shown in FIG. 1, the automatic driving system 20 includes a camera 21 (imaging device), the state estimation apparatus 10, and an automatic driving support apparatus 22. The automatic driving system 20 automatically drives a vehicle C while monitoring a driver D in the vehicle C. The vehicle C may be of any type that can incorporate an automatic driving system, such as an automobile.

The camera 21, which corresponds to the imaging device of the claimed invention, is placed as appropriate to capture an image of a scene that is likely to include a target person. In the present embodiment, the driver D seated in a driver's seat of the vehicle C corresponds to the target person of the claimed invention. The camera 21 is placed as appropriate to capture an image of the driver D. For example, the camera 21 is placed above and in front of the driver's seat of the vehicle C to continuously capture an image of the front of the driver's seat in which the driver D is likely to be seated. The captured image may include substantially the entire upper body of the driver D. The camera 21 transmits the captured image to the state estimation apparatus 10. The captured image may be a still image or a moving image.

The state estimation apparatus 10 is a computer that obtains the captured image from the camera 21, and analyzes the obtained captured image to estimate the state of the driver D. More specifically, the state estimation apparatus 10 analyzes the facial behavior of the driver D based on the captured image obtained from the camera 21 to obtain first information about the facial behavior of the driver D (first information 122 described later). The state estimation apparatus 10 also analyzes body movement of the driver D based on the captured image to obtain second information about the body movement of the driver D (second information 123 described later). The state estimation apparatus 10 estimates the state of the driver D based on the obtained first and second information.

The automatic driving support apparatus 22 is a computer that controls the drive system and the control system of the vehicle C to implement a manual drive mode in which the driving operation is manually performed by the driver D or an automatic drive mode in which the driving operation is automatically performed independently of the driver D. In the present embodiment, the automatic driving support apparatus 22 switches between the manual drive mode and the automatic drive mode in accordance with, for example, the estimation result from the state estimation apparatus 10 or the settings of a car navigation system.

As described above, the automatic driving support apparatus 22 according to the present embodiment obtains the first information about the facial behavior of the driver D and the second information about the body movement to estimate the state of the driver D. The apparatus thus estimates the state of the driver D using such overall information indicating the body movement of the driver D in addition to the local information indicating the facial behavior of the driver D. The apparatus according to the present embodiment can thus estimate various possible states of the driver D. The estimation result may be used for automatic driving control to control the vehicle C appropriately for various possible states of the driver D.

### 2. Example Configuration

### Hardware Configuration

The hardware configuration of the state estimation apparatus 10 according to the present embodiment will now be described with reference to FIG. 2. FIG. 2 is a schematic diagram of the state estimation apparatus 10 according to the present embodiment showing its hardware configuration.

As shown in FIG. 2, the state estimation apparatus 10 according to the present embodiment is a computer including a control unit 110, a storage unit 120, and an external interface 130 that are electrically connected to one another. In FIG. 2, the external interface is abbreviated as an external I/F.

The control unit 110 includes, for example, a central processing unit (CPU) as a hardware processor, a random access memory (RAM), and a read only memory (ROM). The control unit 110 controls each unit in accordance with intended information processing. The storage unit 120 includes, for example, a RAM and a ROM, and stores a program 121, the first information 122, the second information 123, and other information. The storage unit 120 corresponds to the memory.

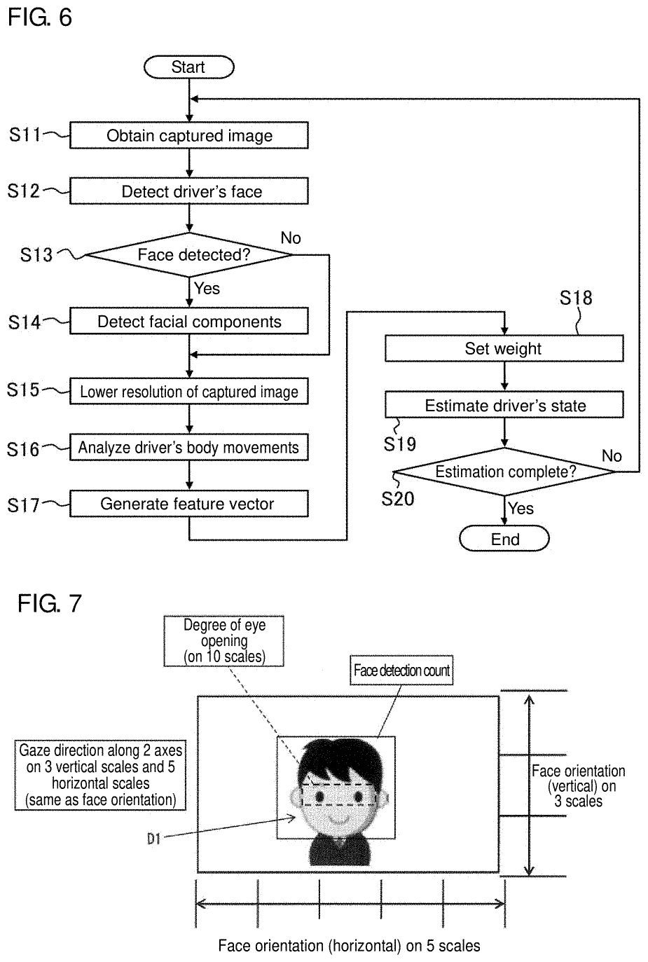

The program 121 is executed by the state estimation apparatus 10 to implement information processing described later (FIG. 6) for estimating the state of the driver D. The first information 122 results from analyzing the facial behavior of the driver D in the image captured by the camera 21. The second information 123 results from analyzing the body movement of the driver D in the image captured by the camera 21. This will be described in detail later.

The external interface 130 for connection with external devices is designed as appropriate depending on the external devices. In the present embodiment, the external interface 130 is, for example, connected to the camera 21 and the automatic driving support apparatus 22 through the Controller Area Network (CAN).

As described above, the camera 21 is placed to capture an image of the driver D in the driver's seat of the vehicle C. In the example shown in FIG. 1, the camera 21 is placed above and in front of the driver's seat. However, the camera 21 may be located at any other position to capture an image of the driver D in the driver's seat, which may be selected as appropriate depending on each embodiment. The camera 21 may be a typical digital camera or video camera.

Similarly to the state estimation apparatus 10, the automatic driving support apparatus 22 may be a computer including a control unit, a storage unit, and an external interface that are electrically connected to one another. In this case, the storage unit stores programs and various sets of data that allow switching between the automatic drive mode and the manual drive mode for supporting the driving operation of the vehicle C. The automatic driving support apparatus 22 is connected to the state estimation apparatus 10 through the external interface. The automatic driving support apparatus 22 thus controls the automatic driving operation of the vehicle C using an estimation result from the state estimation apparatus 10.

The external interface 130 may be connected to any external device other than the external devices described above. For example, the external interface 130 may be connected to a communication module for data communication through a network. The external interface 130 may be connected to any other external device selected as appropriate depending on each embodiment. In the example shown in FIG. 2, the state estimation apparatus 10 includes the single external interface 130. However, the state estimation apparatus 10 may include any number of external interfaces 130 as appropriate depending on each embodiment. For example, the state estimation apparatus 10 may include multiple external interfaces 130 corresponding to the external devices to be connected.

The state estimation apparatus 10 according to the present embodiment has the hardware configuration described above. However, the state estimation apparatus 10 may have any other hardware configuration determined as appropriate depending on each embodiment. For the specific hardware configuration of the state estimation apparatus 10, components may be eliminated, substituted, or added as appropriate in different embodiments. For example, the control unit 110 may include multiple hardware processors. The hardware processors may be a microprocessor, a field-programmable gate array (FPGA), and other processors. The storage unit 120 may include the RAM and the ROM included in the control unit 110. The storage unit 120 may also be an auxiliary storage device such as a hard disk drive or a solid state drive. The state estimation apparatus 10 may be an information processing apparatus dedicated to an intended service or may be a general-purpose computer.

### Functional Components

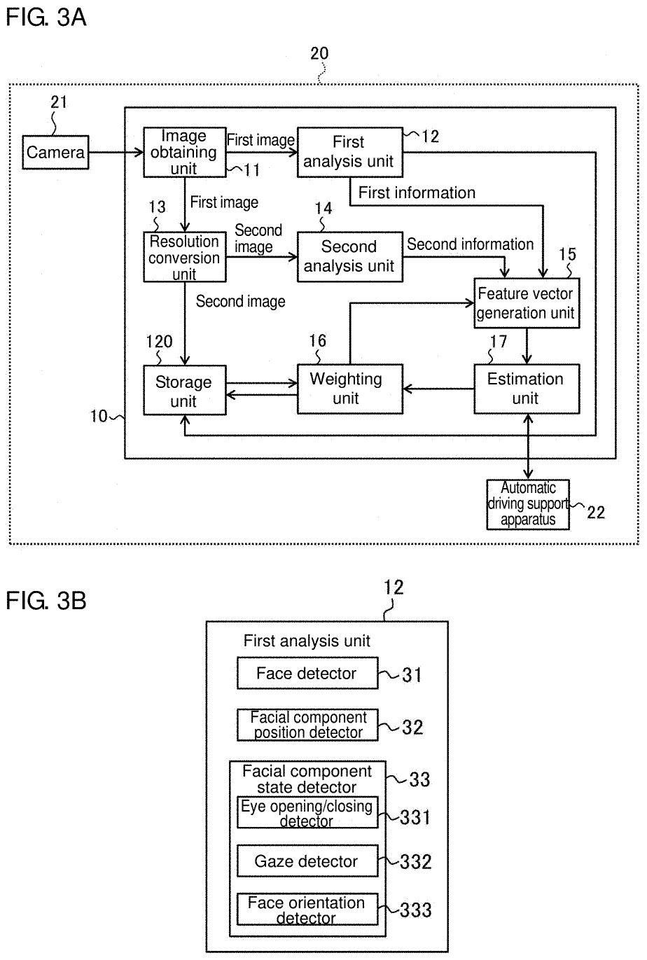

The state estimation apparatus 10 includes example functional components according to the present embodiment described with reference to FIG. 3A. FIG. 3A is a schematic diagram of the state estimation apparatus 10 according to the present embodiment showing its functional components.

The control unit 110 included in the state estimation apparatus 10 expands the program 121 stored in the storage unit 120 into the RAM. The CPU in the control unit 110 then interprets and executes the program 121 expanded in the RAM to control each unit. As shown in FIG. 3A, the program is executed by the state estimation apparatus 10 according to the present embodiment to function as a computer including an image obtaining unit 11, a first analysis unit 12, a resolution conversion unit 13, a second analysis unit 14, a feature vector generation unit 15, a weighting unit 16, and an estimation unit 17.

The image obtaining unit 11 obtains a captured image (or a first image) from the camera 21 placed to capture an image of the driver D. The image obtaining unit 11 then transmits the obtained first image to the first analysis unit 12 and the resolution conversion unit 13.

The first analysis unit 12 analyzes the facial behavior of the driver D in the obtained first image to obtain the first information about the facial behavior of the driver D. The first information may be any information about the facial behavior, which can be determined as appropriate depending on each embodiment. The first information may indicate, for example, at least whether a face is detected, the face position, the face orientation, the face movement, the gaze direction, the facial component positions, or the eye opening or closing of the driver D (target person). The first analysis unit 12 may have the configuration below.

FIG. 3B is a schematic diagram of the first analysis unit 12 according to the present embodiment. As shown in FIG. 3B, the first analysis unit 12 according to the present embodiment includes a face detector 31, a facial component position detector 32, and a facial component state detector 33. The facial component state detector 33 includes an eye opening/closing detector 331, a gaze detector 332, and a face orientation detector 333.

The face detector 31 analyzes image data representing the first image to detect the face or the face position of the driver D in the first image. The facial component position detector 32 detects the positions of the components included in the face of the driver D (such as the eyes, the mouth, the nose, and the ears) detected in the first image. The facial component position detector 32 may also detect the contour of the entire or a part of the face as an auxiliary facial component.

The facial component state detector 33 estimates the states of the face components of the driver D, for which the positions have been detected in the first image. More specifically, the eye opening/closing detector 331 detects the degree of eye opening of the driver D. The gaze detector 332 detects the gaze direction of the driver D. The face orientation detector 333 detects the face orientation of the driver D.

However, the facial component state detector 33 may have any other configuration. The facial component state detector 33 may detect information about other states of the facial components. For example, the facial component state detector 33 may detect face movement. The analysis results from the first analysis unit 12 are transmitted to the feature vector generation unit 15 as the first information (local information) about the facial behavior. As shown in FIG. 3A, the analysis results (first information) from the first analysis unit 12 may be accumulated in the storage unit 120.

The resolution conversion unit 13 lowers a resolution of the image data representing the first image to generate a captured image (or second image) having a lower resolution than the first image. The second image may be temporarily stored in the storage unit 120. The second analysis unit 14 analyzes the body movement of the driver D in the second image with a lower resolution to obtain second information about the driver's body movement.

The second information may be any information about the driver's body movement that can be determined as appropriate depending on each embodiment. The second information may indicate, for example, the body motion or the posture of the driver D. The analysis results from the second analysis unit 14 are transmitted to the feature vector generation unit 15 as second information (overall information) about the body movement of the driver D. The analysis results (second information) from the second analysis unit 14 may be accumulated in the storage unit 120.

The feature vector generation unit 15 receives the first information and the second information, and generates a feature vector indicating the facial behavior and the body movement of the driver D. As described later, the first information and the second information are each represented by feature quantities obtained from the corresponding detection results. The feature quantities representing the first and second information may also be collectively referred to as movement feature quantities. More specifically, the movement feature quantities include both the information about the facial components of the driver D and the information about the body movement of the driver D. The feature vector generation unit 15 generates a feature vector including the movement feature quantities as elements.

The weighting unit 16 determines, for each of the elements (each of the feature quantities) of the generated feature vector, a weight defining a priority among the elements (feature quantities). The weights may be any values determined as appropriate. The weighting unit 16 according to the present embodiment determines the values of the weights on the elements based on the past estimation result of the state of the driver D from the estimation unit 17 (described later). The weighting data is stored as appropriate into the storage unit 120.

The estimation unit 17 estimates the state of the driver D based on the first information and the second information. More specifically, the estimation unit 17 estimates the state of the driver D based on a state vector, which is a weighted feature vector. The state of the driver D to be estimated may be determined as appropriate depending on each embodiment. For example, the estimation unit 17 may estimate, as the state of the driver D, at least looking forward carefully, feeling drowsy, looking aside, putting on or taking off clothes, operating a phone, leaning against the window or an armrest, being interrupted in driving by a passenger or a pet, suffering a disease attack, looking back, resting the head on the arms, eating and drinking, smoking, feeling dizzy, taking abnormal movement, operating the car navigation system or the audio system, putting on or taking off glasses or sunglasses, or taking a photograph.

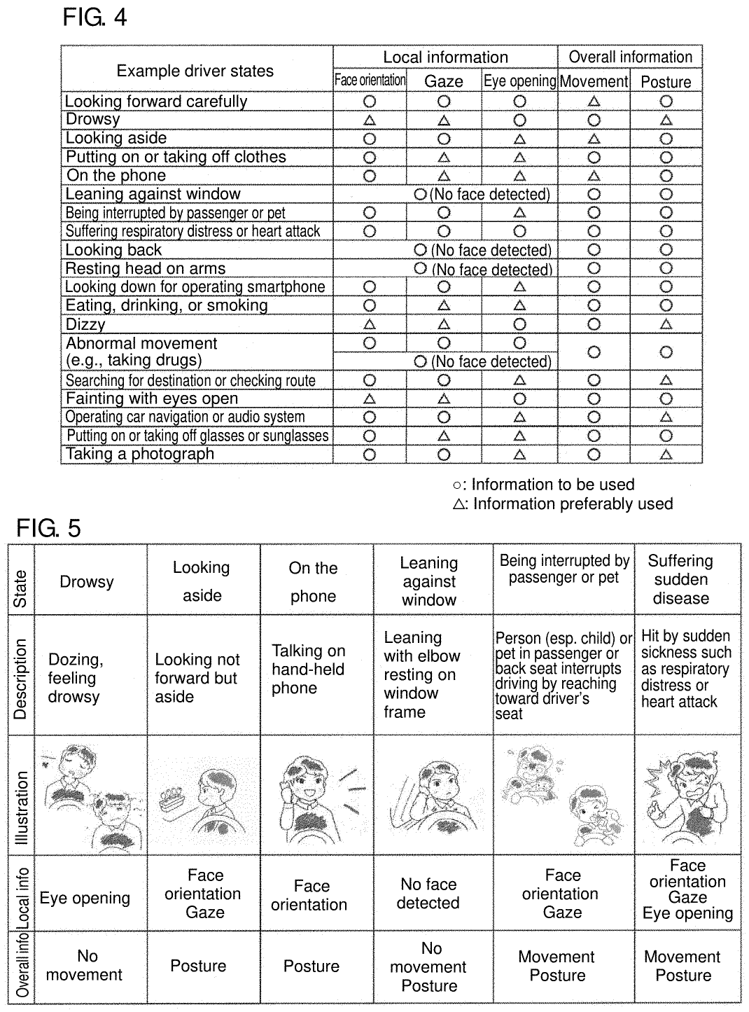

FIG. 4 is a table showing example combinations of the states of the driver D and information used to estimate the states. As shown in FIG. 4, the first information about facial behavior (local information) may be combined with the second information about the body movement (overall information) to appropriately estimate various states of the driver D. In FIG. 4, the circle indicates that the information is to be used to estimate the state of the target driver, the triangle indicates that the information may preferably be used to estimate the state of the target driver.

FIG. 5 is a table showing example conditions for estimating the state of the driver D. For example, the driver D feeling drowsy may close his or her eyes and stop his or her body movement. The estimation unit 17 may thus use the degree of eye opening detected by the first analysis unit 12 as local information and also information about the movement of the driver D detected by the second analysis unit 14 as overall information to determine whether the driver D is feeing drowsy.

For example, the driver D looking aside may have his or her face orientation and gaze direction deviating from the front direction and have his or her body turned in a direction other than the front direction. Thus, the estimation unit 17 may use information about the face orientation and the gaze detected by the first analysis unit 12 as local information and information about the posture of the driver D detected by the second analysis unit 14 as overall information to determine whether the driver D is looking aside.

For example, the driver D operating a mobile terminal (or talking on the phone) may have his or her face orientation deviating from the front direction and have his or her posture changing accordingly. Thus, the estimation unit 17 may use information about the face orientation detected by the first analysis unit 12 as local information and information about the posture of the driver D detected by the second analysis unit 14 as overall information to determine whether the driver D is operating a mobile terminal.

For example, the driver D leaning against the window (door) with an elbow resting on it may have his or her face not in a predetermined position appropriate to driving, become motionless and lose his or her posture. Thus, the estimation unit 17 may use information about the face position detected by the first analysis unit 12 as local information and information about the movement and the posture of the driver D detected by the second analysis unit 14 as overall information to determine whether the driver D is leaning against the window.

For example, the driver D being interrupted in driving by a passenger or a pet may have his or her face orientation and gaze deviating from the front direction, and move the body in response to the interruption, and change the posture to avoid such interruption. The estimation unit 17 may thus use information about the face orientation and the gaze direction detected by the first analysis unit 12 as local information and information about the movement and the posture of the driver D detected by the second analysis unit 14 as overall information to determine whether the driver D is being interrupted in driving.

For example, the driver D suffering a sudden disease attack (such as respiratory distress or a heart attack) may have his or her face orientation and gaze deviating from the front direction, close the eyes, and move and change his or her posture to hold a specific body part. The estimation unit 17 may thus use information about the degree of eye opening, the face orientation, and the gaze detected by the first analysis unit 12 as local information and information about the movement and the posture of the driver D detected by the second analysis unit 14 as overall information to determine whether the driver D is suffering a sudden disease attack.

The functions of the state estimation apparatus 10 will be described in the operation examples described below. In the present embodiment, each function of the state estimation apparatus 10 is implemented by a general-purpose CPU. In some embodiments, some or all of the functions may be implemented by one or more dedicated processors. For the functional components of the state estimation apparatus 10, components may be eliminated, substituted, or added as appropriate in different embodiments.

### 3. Operation Examples

Operation examples of the state estimation apparatus 10 will now be described with reference to FIG. 6. FIG. 6 is a flowchart of a procedure performed by the state estimation apparatus 10. The procedure described below for estimating the state of the driver D corresponds to the state estimation method of the claimed invention. However, the procedure described below is a mere example, and each of its process may be modified in any possible manner. In the procedure described below, steps may be eliminated, substituted, or added as appropriate in different embodiments.

### Step S11

In step S11, the control unit 110 first functions as the image obtaining unit 11 to obtain a captured image from the camera 21 placed to capture an image of the driver D in the driver's seat of the vehicle C. The captured image may be a moving image or a still image. In the present embodiment, the control unit 110 continuously obtains a captured image as image data from the camera 21. The obtained captured image thus includes multiple frames.

### Steps S12 to S14

In steps S12 to S14, the control unit 110 functions as the first analysis unit 12 to perform predetermined image analysis of the obtained captured image (first image). The control unit 110 analyzes the facial behavior of the driver D based on the captured image to obtain first information about the facial behavior of the driver D.

More specifically, in step S12, the control unit 110 first functions as the face detector 31 included in the first analysis unit 12 to detect the face of the driver D in the obtained captured image. The face may be detected with a known image analysis technique. The control unit 110 obtains information about whether the face is detected and the face position.

In step S13, the control unit 110 determines whether the face is detected based on the captured image in step S12. With the face detected, the control unit 110 advances to step S14. With no face detected, the control unit 110 skips step S14 and advances to step S15. With no face detected, the control unit 110 sets the detection results indicating the face orientation, the degree of eye opening, and the gaze direction to zero.

In step S14, the control unit 110 functions as the facial component position detector 32 to detect the facial components of the driver D (such as the eyes, the mouth, the nose, and the ears) in the detected face image. The components may be detected with a known image analysis technique. The control unit 110 obtains information about the facial component positions. The control unit 110 also functions as the facial component state detector 33 to analyze the state of each detected component to detect, for example, the face orientation, the face movement, the degree of eye opening, and the gaze direction.

A method for detecting the face orientation, the degree of eye opening, and the gaze direction will now be described with reference to FIG. 7. FIG. 7 is a schematic diagram describing the method for detecting the face orientation, the degree of eye opening, and the gaze direction. As shown in FIG. 7, the control unit 110 functions as the face orientation detector 333 to detect the face orientation of the driver D based on the captured image along two axes, namely the vertical and horizontal axes, on a vertical scale of three and a horizontal scale of five. The control unit 110 also functions as the gaze detector 332 to detect the gaze direction of the driver D in the same manner as the face orientation, or specifically along the two axes, namely the vertical and horizontal axes, on a vertical scale of three and a horizontal scale of five. The control unit 110 further functions as the eye opening/closing detector 331 to detect the degree of eye opening of the driver D based on the captured image on a scale of ten.

In the above manner, the control unit 110 obtains, as the first information, information about whether the face is detected, the face position, the face orientation, the face movement, the gaze direction, the facial component positions, and the degree of eye opening of the driver D. The first information may be obtained per frame. More specifically, the obtained captured image including multiple frames may be analyzed by the control unit 110 to detect the facial behavior on a frame basis to generate the first information. In this case, the control unit 110 may analyze the facial behavior in every frame or at intervals of a predetermined number of frames. Such analysis enables detection of a slight change in the facial behavior of the driver D in each frame, and thus can generate the first information indicating a detailed facial behavior of the driver D. The processing from steps S12 to S14 according to the present embodiment is performed using the image as captured by the camera 21 (first image).

### Steps S15 and S16

Referring back to FIG. 6, in step S15, the control unit 110 functions as the resolution conversion unit 13 to lower the resolution of the captured image obtained in step S11. The control unit 110 thus forms a captured image with a lower resolution (second image) on a frame basis. The resolution may be lowered with any technique selectable depending on each embodiment. For example, the control unit 110 may use a nearest neighbor algorithm, bilinear interpolation, or bicubic interpolation to form the captured image with a lower resolution.

In step S16, the control unit 110 functions as the second analysis unit 14 to analyze the body movement of the driver D based on the captured image with a lower resolution (second image) to obtain the second information about the body movement of the driver D. The second information may include, for example, information about the posture of the driver D, the upper body movement, and the presence of the driver D.

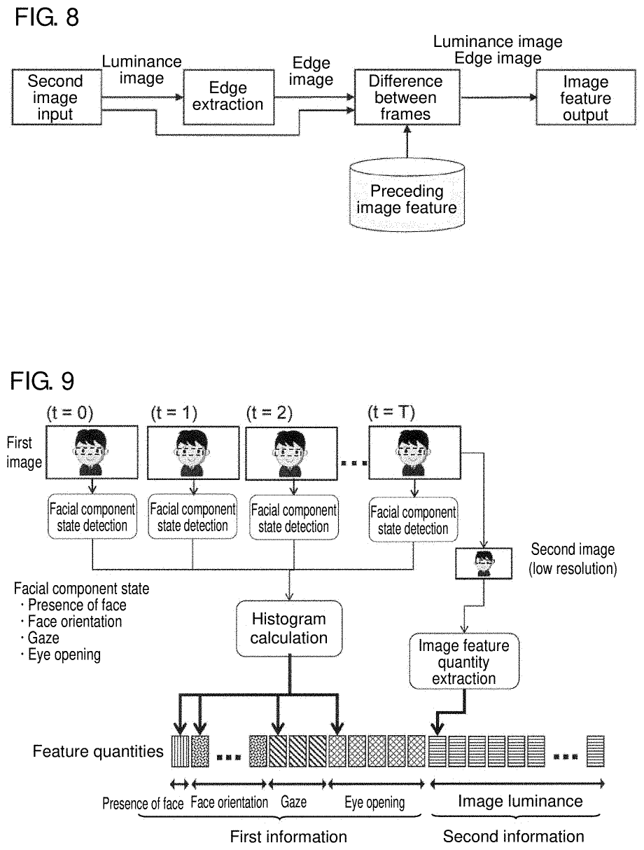

A method for detecting the second information about the body movement of the driver D will now be described with reference to FIG. 8. FIG. 8 is a schematic diagram describing a process for detecting the second information from the captured image with a lower resolution. In the example shown in FIG. 8, the control unit 110 extracts the second information from the second image as image feature quantities.

More specifically, the control unit 110 extracts edges in the second image based on the luminance of each pixel. The edges may be extracted using a predesigned (e.g., 3×3) image filter. The edges may also be extracted using a learner (e.g., a neural network) that has learned edge detection through machine learning. The control unit 110 may enter the luminance of each pixel of a second image into such an image filter or a learner to detect edges included in the second image.

The control unit 110 then compares the information about the luminance and the extracted edges of the second image corresponding to the current frame with the information about the luminance and the extracted edges of a preceding frame to determine the difference between the frames. The preceding frame refers to a frame preceding the current frame by a predetermined number (e.g., one) of frames. Through the comparison, the control unit 110 obtains, as image feature quantities (second information), four types of information, or specifically, luminance information on the current frame, edge information indicating the edge positions in the current frame, luminance difference information obtained in comparison with the preceding frame, and edge difference information obtained in comparison with the preceding frame. The luminance information and the edge information mainly indicate the posture of the driver D and the presence of the driver D. The luminance difference information and the edge difference information mainly indicate the movement of the driver D (upper body).

In addition to the above edge positions, the control unit 110 may also obtain image feature quantities about the edge strength and local frequency components of an image. The edge strength refers to the degree of variation in the luminance along and near the edges included in an image. The local frequency components of an image refer to image feature quantities obtained by subjecting the image to image processing such as the Gabor filter, the Sobel filter, the Laplacian filter, the Canny edge detector, and the wavelet filter. The local frequency components of an image may also be image feature quantities obtained by subjecting the image to other image processing, such as image processing through a filter predesigned through machine learning. The resultant second information appropriately indicates the body state of the driver D independently of the body size of the driver D or the position of the driver D changeable by a slidable driver's seat.

In the present embodiment, the captured image (first image) includes multiple frames, and thus the captured image with a lower resolution (second image) also includes multiple frames. The control unit 110 analyzes body movement in two or more frames included in the second image to obtain the second information, such as the luminance difference information and the edge difference information. The control unit 110 may selectively store frames to be used for calculating the differences into the storage unit 120 or the RAM. The memory thus stores no unused frame, and allows efficient use of the capacity. Multiple frames used to analyze body movement may be temporally adjacent to each other. However, body movement of the driver D may change slower than the change in each facial component. Thus, multiple frames at predetermined time intervals may be used efficiently to analyze the body movement of the driver D.

A captured image may include the body movement of the driver D appearing greater than the facial behavior. Thus, the captured image having a lower resolution than the captured image used to obtain the first information about the facial behavior in steps S12 to S14 may be used to obtain the second information about the body movement in step S16. In the present embodiment, the control unit 110 thus performs step S15 before step S16 to obtain a captured image (second image) having a lower resolution than the captured image (first image) used to obtain the first information about the facial behavior. The control unit 110 then uses the captured image with a lower resolution (second image) to obtain the second information about the body movement of the driver D. This process reduces the computation for obtaining the second information and the processing load on the control unit 110 in step S16.

Steps S15 and S16 may be performed in parallel with steps S12 to S14. Steps S15 and S16 may be performed before steps S12 to S14. Steps S15 and S16 may be performed between steps S12 and S13 or steps S13 and S14. Step S15 may be performed before step S12, S13, or S14, and step S16 may be performed after steps S12, S13, or S14. In other words, steps S15 and S16 may be performed independently of steps S12 to S14.

### Step S17

Referring back to FIG. 6, in step S17, the control unit 110 functions as the feature vector generation unit 15 to generate a feature vector using the obtained first and second information.

An example process for generating a feature vector will now be described with reference to FIG. 9. FIG. 9 is a schematic diagram describing the process for calculating the elements (feature quantities) in a feature vector. As shown in FIG. 9, the camera 21 continuously captures an image. The captured image (first image) obtained in step S11 thus includes multiple frames at time t=0, 1, . . . , T.

In steps S12 to S14, the control unit 110 functions as the first analysis unit 12 to analyze the facial behavior in the obtained first image on a frame basis. The control unit 110 thus calculates, as the first information, feature quantities (histogram) each indicating whether the face of the driver D is detected, the face position, the face orientation, the face movement, the gaze direction, the facial component positions, and the degree of eye opening of the driver D.

In step S15, the control unit 110 functions as the resolution conversion unit 13 to form a second image by lowering the resolution of the first image. In step S16, the control unit 110 functions as the second analysis unit 14 to extract image feature quantities as the second information from two or more frames included in the formed second image.

The control unit 110 sets the feature quantities obtained as the first and second information to the elements in a feature vector. The control unit 110 thus generates the feature vector indicating the facial behavior and the body movement of the driver D.

### Steps S18 to S20

Referring back to FIG. 6, in step S18, the control unit 110 functions as the weighting unit 16 to determine, for each element (each feature quantity) in the feature vector, a weight defining a priority among the elements. In step S19, the control unit 110 estimates the state of the driver D based on the state vector obtained by applying the determined weight to the feature vector, or more specifically the feature quantity values weighted using the determined weight. As shown in FIGS. 4 and 5, the control unit 110 can estimate, as the state of the driver D, for example, at least looking forward carefully, feeling drowsy, looking aside, putting on or taking off clothes, operating a phone, leaning against the window or an armrest, being interrupted in driving by a passenger or a pet, suffering a disease attack, looking back, resting the head on the arms, eating and drinking, smoking, feeling dizzy, taking abnormal movement, operating the car navigation system or the audio system, putting on or taking off glasses or sunglasses, or taking a photograph.

In step S20, in response to an instruction (not shown) from the automatic driving system 20, the control unit 110 determines whether to continue estimating the state of the driver D. When determining to stop estimating the state of the driver D, the control unit 110 ends the processing associated with this operation example. For example, the control unit 110 determines to stop estimating the state of the driver D when the vehicle C stops, and ends monitoring of the state of the driver D. When determining to continue estimating the state of the driver D, the control unit 110 repeats the processing in step S11 and subsequent steps. For example, the control unit 110 determines to continue estimating the state of the driver D when the vehicle C continues automatic driving, and repeats the processing in step S11 and subsequent steps to continuously monitor the state of the driver D.

In the process of repeatedly estimating the state of the driver D, the control unit 110 uses, in step S18, the past estimation results of the state of the driver D obtained in step S19 to determine the values of the weights on the elements. More specifically, the control unit 110 uses the estimation results of the state of the driver D to determine the weight on each feature quantity to prioritize the items (e.g., the facial components, the body movement, or the posture) to be mainly used in the cycle next to the current estimation cycle to estimate the state of the driver D.

When, for example, the driver D is determined to be looking back at a point in time, the captured first image likely to include almost no facial components of the driver D, such as the eyes, but can include the contour of the face of the driver D for a while after the determination. In this case, the control unit 110 determines that the state of the driver D is likely to look front in the next cycle. The control unit 110 may increase the weight on the feature quantity indicating the presence of the face and reduce the weights on the feature quantities indicating the gaze direction and the degree of eye opening.

While changing the weighting values in step S18, the control unit 110 may repeat the estimation processing in step S19 until the estimation result of the state of the driver D exceeds a predetermined likelihood. The threshold for the likelihood may be preset and stored in the storage unit 120 or set by a user.

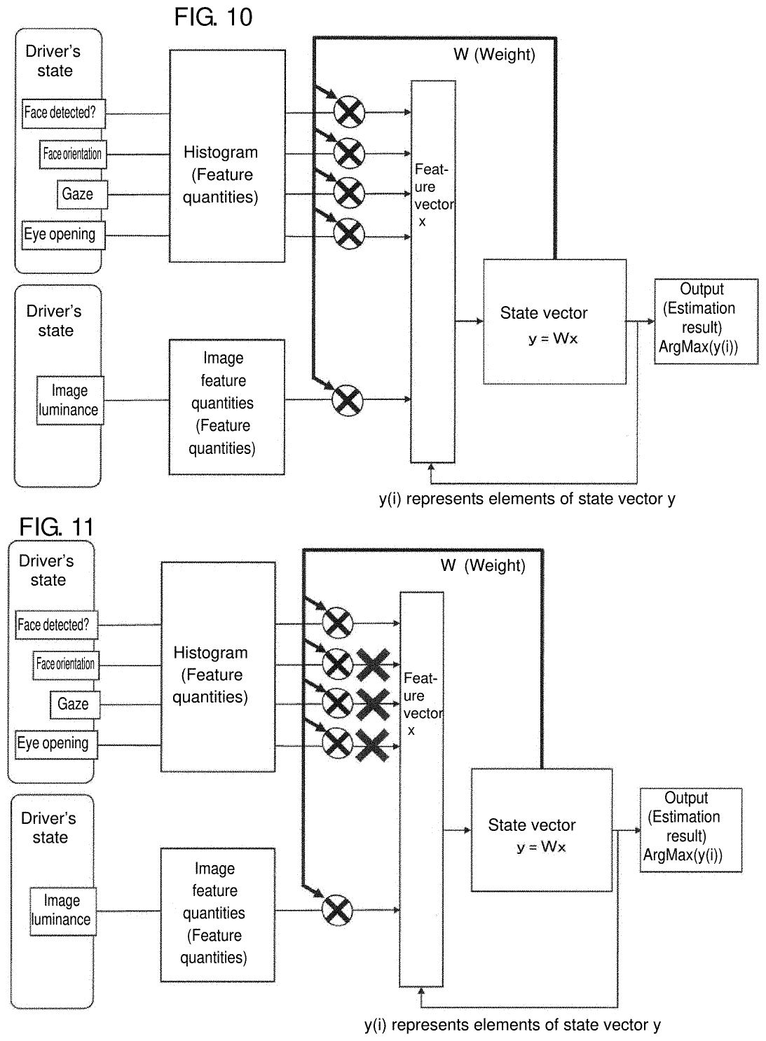

The process for changing the weights for the current cycle based on the estimation result obtained in the preceding cycle will now be described in detail with reference to FIGS. 10 and 11. FIG. 10 is a diagram describing a process for estimating the state of the driver based on each feature quantity and a process for changing the weight on each feature quantity in accordance with the estimation result. FIG. 11 is a diagram describing weighting that follows determined looking back by the driver D.

As shown in FIG. 10, the control unit 110 obtains a feature vector x in step S17. The feature vector x includes, as its elements, feature quantities associated with, for example, the presence of the face, the face orientation, the gaze direction, and the degree of eye opening (first information), and feature quantities associated with, for example, the body movement and the posture (second information). The control unit 110 weights the elements in the feature vector x, or more specifically, multiplies the feature vector x by the weight vector W to calculate the state vector y (=Wx). Each element in the weight vector W has a weight defined for the corresponding feature quantity. In step S19, the control unit 110 estimates the state of the driver D based on the state vector y.

In the example shown in FIG. 10, the control unit 110 outputs, as the estimation result, ArgMax(y(i)), which is the index of the largest element value of the elements in the state vector y. For y=(y(1), y(2), y(3)), ArgMax(y(i)) denotes the value i corresponding to the largest one of y(i) (i=1, 2, 3). When, for example, the state vector y=(0.3, 0.5, 0.1), ArgMax(y(i))=2.

In this example, the elements in the state vector y are associated with the states of the driver D. When, for example, the first element is associated with looking forward carefully, the second element is associated with feeling drowsy, and the third element is associated with looking aside, the output ArgMax(y(i))=2 indicates the estimation result of the driver D feeling drowsy.

Based on the estimation result, the control unit 110 changes the value of each element in the weight vector W used in the next cycle. The value of each element in the weight vector W corresponding to the estimation result may be determined as appropriate depending on each embodiment. The value of each element in the weight vector W may also be determined through machine learning such as reinforcement learning. With no past estimation results, the control unit 110 may perform weighting as appropriate using predefined initial values.

For example, the value of ArgMax(y(i)) may indicate that the driver D is looking back at a point in time. The next operation of the driver D is likely to be looking front. In this case, the control unit 110 determines not to use the facial component feature quantities associated with, for example, the face orientation, the gaze direction, and the degree of eye opening to estimate the state of the driver D until the face of the driver D is detected in a captured image.

Thus, when determining that the driver D is looking back, as shown in FIG. 11, the control unit 110 may gradually reduce the weights on the facial component feature quantities associated with, for example, the face orientation, the gaze direction, and the degree of eye opening in step S18 in the next and subsequent cycles. In contrast, the control unit 110 may gradually increase the weights on the face presence feature quantities. This process can prevent the facial component feature quantities from affecting the estimation of the state of the driver D in the next and subsequent cycles until the driver D is determined to be looking front. After the driver D is determined to be looking front, the obtained captured image may show the facial components of the driver D. Thus, when the driver D is determined to be looking front, the control unit 110 may increase the weights on the facial component feature quantities associated with, for example, the face orientation, the gaze direction, and the degree of eye opening in step S18 in the next and subsequent cycles.

When the weight value is zero or smaller than a threshold, the control unit 110 may temporarily stop detecting the corresponding feature quantity. In the above example of looking back, when the weights become zero on the facial component feature quantities associated with, for example, the face orientation, the gaze direction, and the degree of eye opening, the control unit 110 may not detect the face orientation, the gaze direction, and the degree of eye opening in step S14. This process reduces the computation for the entire processing and accelerates the processing speed of estimating the state of the driver D.

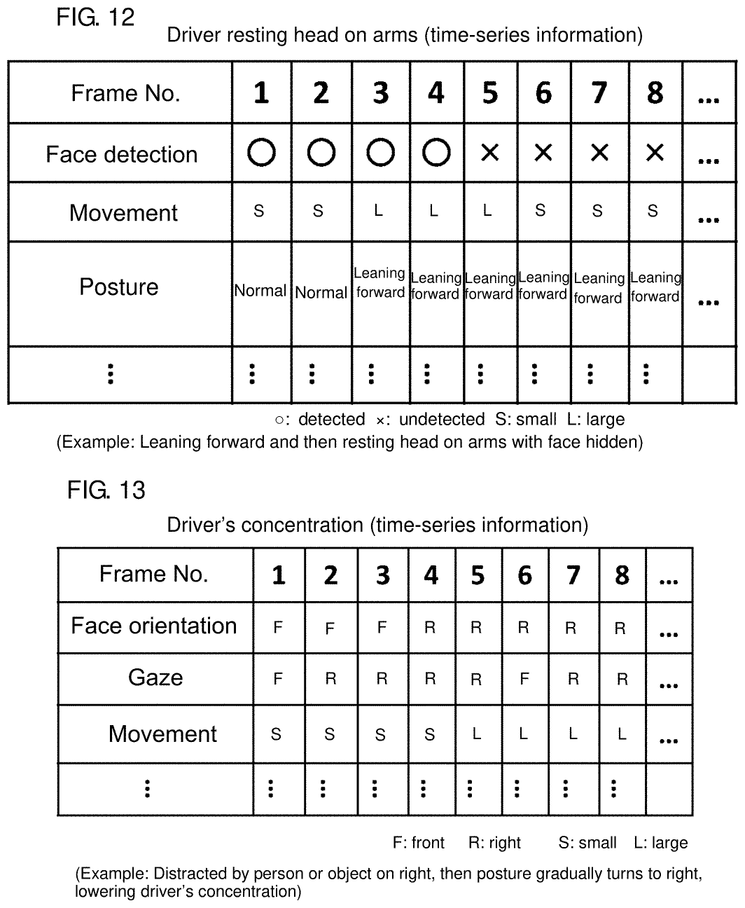

Specific examples of the feature quantities detected during the repetitive processing of steps S11 to S20 and the states of the driver D estimated in accordance with the detected feature quantities will now be described with reference to FIGS. 12 and 13. FIG. 12 is a table showing example feature quantities (time-series information) detected when the driver D rests the head on the arms. FIG. 13 is a table showing example feature quantities (time-series information) detected when the driver D distracted by an object on the right gradually lowers his or her concentration.

The example shown in FIG. 12 will be described first. When the driver D rests the head on the arms, the detected face may be hidden. The body may be likely to move greatly and then stop, and then the posture may be likely to shift from the normal driving posture to leaning forward. The control unit 110 thus sets the weight vector W accordingly, and then detects such a change in step S19 to determine that the driver D is resting the head on the arms.

In the example shown in FIG. 12, the face of the driver D detected in frame No. 4 is hidden (undetected) between frames No. 4 and No. 5. The body movement of the driver D increases in frames No. 3 to No. 5 and stops in frame No. 6. The posture of the driver D shifts from the normal driving posture to leaning forward between frames No. 2 to No. 3. The control unit 110 may detect these changes based on the state vector y to determine that the driver D has rested the head on the arms in frames No. 3 to No. 6.

The example shown in FIG. 13 will now be described. FIG. 13 illustrates an example in which the driver D is gradually lowering his or her concentration on driving. When the driver D is concentrating on driving, the driver D moves the body little and looks forward. In contrast, when the driver D concentrates less on driving, the driver D turns the face or gaze in a direction other than the front and greatly moves the body. The control unit 110 may set the weight vector W accordingly, and estimate, in step S19, the degree of concentration on driving as the state of the driver D based on the feature quantities associated with the face orientation, the gaze direction, and the body movement of the driver D.

In the example shown in FIG. 13, the driver D looking forward turns the face to the right between frames No. 3 and No. 4. The forward gaze of the driver D turns to the right in frames No. 2 to No. 4, and temporarily returns in the forward direction in frame No. 6 before turning to the right again in frame No. 7. The movement of the driver D increases between frames No. 4 and No. 5. The control unit 110 may detect these changes based on the state vector y to determine that the driver D is gradually distracted by an object on the right from frame No. 2 to gradually turn the posture to the right, and lowering his or her concentration.

The control unit 110 transmits the estimation result to the automatic driving support apparatus 22. The automatic driving support apparatus 22 uses the estimation result from the state estimation apparatus 10 to control the automatic driving operation. When, for example, the driver D is determined to suffer a sudden disease attack, the automatic driving support apparatus 22 may control the operation of the vehicle C to switch from the manual drive mode to the automatic drive mode, and move the vehicle C to a safe place (e.g., a nearby hospital, a nearby parking lot) before stopping.

### Advantages and Effects

As described above, the state estimation apparatus 10 according to the present embodiment obtains, in steps S12 to S14, first information about the facial behavior of the driver D based on the captured image (first image) obtained from the camera 21 placed to capture an image of the driver D. The state estimation apparatus 10 also obtains, in step S16, second information about the body movement of the driver D based on a captured image with a lower resolution (second image). The state estimation apparatus 10 then estimates, in step S19, the state of the driver D based on the obtained first and second information.

Thus, the apparatus according to the present embodiment uses local information (first information) about the facial behavior of the driver D as well as overall information (second information) about the body movement of the driver D to estimate the state of the driver D. The apparatus according to the present embodiment can thus estimate various possible states of the driver D as shown in FIGS. 4, 5, 12, and 13.

In step S18, in repeating the processing in steps S11 to S20, the control unit 110 uses the estimation result from the past cycle to change the element values of the weight vector W applied to the feature vector x to use the element values in the estimation in the current cycle. The apparatus according to the present embodiment can thus estimate various states of the driver D accurately.

A captured image may include the body movement appearing greater than the facial behavior. The body movement can thus be sufficiently analyzed by using a captured image having a lower resolution than the captured image used to analyze the facial behavior. The apparatus according to the present embodiment uses the image as captured by the camera 21 (first image) to analyze the facial behavior, and uses another image (second image) obtained by lowering the resolution of the image captured by the camera 21 to analyze the body movement. This reduces the computation for analyzing the body movement and the load on the processor without degrading the accuracy of the state estimation of the driver D. The apparatus according to the present embodiment thus estimates various states of the driver D accurately at high speed with low load.

### 4. Modifications

The embodiments of the present invention described in detail above are mere examples of the present invention in all respects. The embodiments may be variously modified or altered without departing from the scope of the present invention. For example, the embodiments may be modified in the following form. Hereafter, the same components as those in the above embodiments are given the same numerals, and the operations that are the same as those in the above embodiments will not be described. The modifications below may be combined as appropriate.

4.1

In the above embodiment, the first information includes feature quantities associated with whether the face of the driver D is detected, the face position, the face orientation, the face movement, the gaze direction, the facial component positions, and the degree of eye opening of the driver D. The second information includes feature quantities associated with the luminance information on the current frame, the edge information indicating the edge positions in the current frame, the luminance difference information obtained in comparison with the preceding frame, and the edge difference information obtained in comparison with the preceding frame. However, the first information and the second information may each include any number of feature quantities determined as appropriate depending on each embodiment. The first information and the second information may be each represented by one or more feature quantities (movement feature quantities). The first information and the second information may be in any form determined as appropriate depending on each embodiment. The first information may be information associated with at least whether the face of the driver D is detected, the face position, the face orientation, the face movement, the gaze direction, the facial component positions, or the degree of eye opening of the driver D. The second information may be feature quantities associated with at least edge positions, edge strength, or local frequency components of an image extracted from the second image. The first information and the second information may each include feature quantities and information other than those in the above embodiment.

4.2

In the above embodiment, the control unit 110 uses the second image with a lower resolution to analyze the body movement of the driver D (step S16). However, the body movement may also be analyzed in any other manner using, for example, the first image captured by the camera 21. In this case, the resolution conversion unit 13 may be eliminated from the functional components described above, and step S15 may be eliminated from the above procedure.

4.3

The facial behavior analysis in steps S12 to S14, the body movement analysis in step S16, the weight determination in step S18, and the estimation of the state of the driver D in step S19 may be each performed using a learner (e.g., neural network) that has learned the corresponding processing through machine learning. To analyze the facial behavior and the body movement in the captured image, the learner may be, for example, a convolutional neural network including convolutional layers alternate with pooling layers. To use the past estimation results, the learner may be, for example, a recurrent neural network including an internal loop including a path from a middle layer to an input layer.

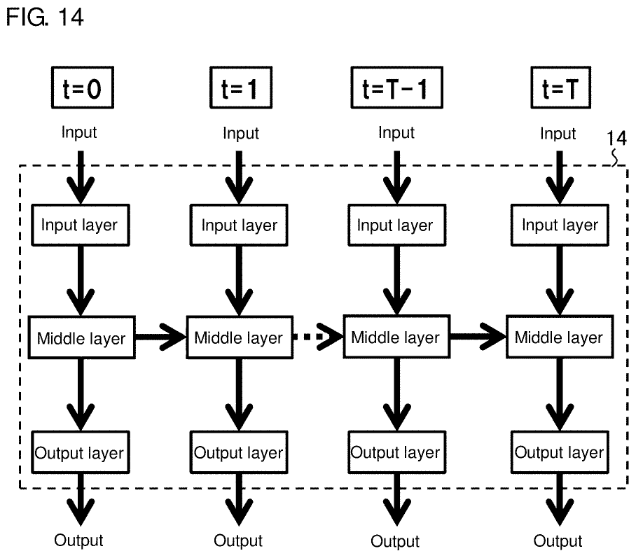

FIG. 14 is a diagram describing the processing performed by an example second analysis unit 14 incorporating a recurrent neural network. The recurrent neural network for the second analysis unit 14 is a multilayer neural network used for deep learning. In the example shown in FIG. 14, the control unit 110 enters the frames of a second image obtained at time t=0, 1, . . . , T−1, and T into an input layer of the neural network. The control unit 110 then determines neuronal firing in each layer starting from the input layer. The control unit 110 thus obtains outputs indicating the analysis results of the body movement from the neural network.

In this neural network, the output from the middle layer between the input layer and the output layer recurs to the input of the middle layer, and thus the output of the middle layer at time t1 is used as an input to the middle layer at time t1+1. This allows the past analysis results to be used for the current analysis, increasing the accuracy in analyzing the body movement of the driver D.

4.4

In the above embodiment, the states of the driver D to be estimated include looking forward carefully, feeling drowsy, looking aside, putting on or taking off clothes, operating a phone, leaning against the window or an armrest, being interrupted in driving by a passenger or a pet, suffering a disease attack, looking back, resting the head on the arms, eating and drinking, smoking, feeling dizzy, taking abnormal movement, operating the car navigation system or the audio system, putting on or taking off glasses or sunglasses, and taking a photograph. However, the states of the driver D to be estimated include any other states selected as appropriate depending on each embodiment. For example, the control unit 110 may have other states such as falling asleep and watching closely a monitor screen as the state of the driver D to be estimated. The state estimation apparatus 10 may show such states on a display (not shown) and receive selection of any of the states to be estimated.

4.5

In the above embodiment, the control unit 110 detects the face and the facial components of the driver D in steps S12 to S14 to detect the face orientation, the gaze direction (a change in gaze), and the degree of eye opening of the driver D. However, the facial behavior to be detected may be a different facial behavior selected as appropriate depending on each embodiment. For example, the control unit 110 may obtain the blink count and the respiratory rate of the driver D as the facial information. In other examples, the control unit 110 may use vital information, such as the pulse, in addition to the first information and the second information to estimate the driver's state.

4.6

In the above embodiment, as shown in FIGS. 1 and 3A, the state estimation apparatus 10 is used in the automatic driving system 20 including the automatic driving support apparatus 22, which controls automatic driving of the vehicle C. However, the state estimation apparatus 10 may have other applications selected as appropriate depending on each embodiment.

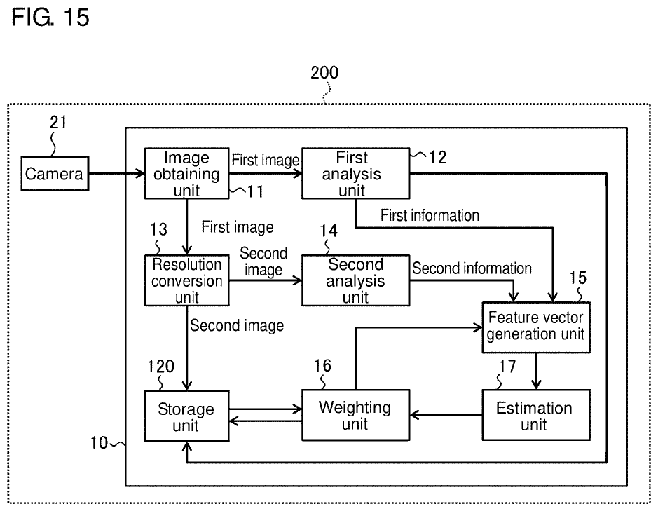

For example, as shown in FIG. 15, the state estimation apparatus 10 may be used in a vehicle system 200 without the automatic driving support apparatus 22. FIG. 15 is a schematic diagram of the state estimation apparatus 10 used in the vehicle system 200 without the automatic driving support apparatus 22. The apparatus according to the present modification has the same structure as the above embodiment except that it eliminates the automatic driving support apparatus 22. The vehicle system 200 according to the present modification may generate an alert as appropriate based on an estimation result indicating the state of the driver D. For example, when any dangerous state such as falling asleep or dangerous driving is detected, the vehicle system 200 may automatically generate an alert to the driver D. When a sudden disease attack is detected, the vehicle system 200 may call an ambulance. In this manner, the vehicle system 200 without the automatic driving support apparatus 22 effectively uses an estimation result from the state estimation apparatus 10.

4.7

In the above embodiment, as shown in FIGS. 3A, 9, and 10, the control unit 110 changes the value of each element in the weight vector W applied to the feature vector x based on the estimation result indicating the state of the driver D. However, this weighting process may be eliminated. The first and second information may also be represented by any form other than feature quantities.

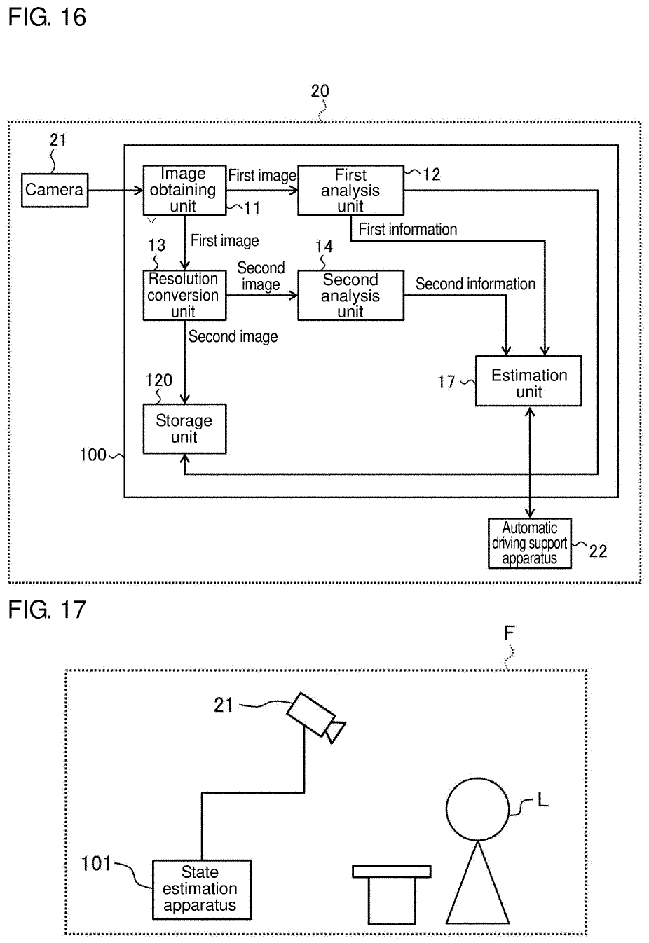

As shown in FIG. 16, the feature vector generation unit 15 and the weighting unit 16 may be eliminated from the functional components of the state estimation apparatus 10. FIG. 16 is a schematic diagram of a state estimation apparatus 100 according to the present modification. The state estimation apparatus 100 has the same structure as the state estimation apparatus 10 according to the above embodiment except that it eliminates the feature vector generation unit 15 and the weighting unit 16.

The state estimation apparatus 100 detects first information about the facial behavior of the driver D based on the first image, and second information about the body movement of the driver D based on a second image obtained by lowering the resolution of the first image. The state estimation apparatus 100 estimates the state of the driver D based on the combination of these detection results. In the same manner as in the above embodiment, this process reduces the computation for analyzing the body movement and the load on the processor without degrading the accuracy in estimating the state of the driver D. The apparatus according to the present modification can thus estimate various states of the driver D accurately at high speed and with low load.

4.8

In the above embodiment, as shown in FIG. 1, the single camera 21 included in the vehicle C continuously captures an image of the driver's seat in which the driver D is likely seated to generate a captured image used to estimate the state of the driver D. However, the image may be captured by multiple cameras 21 instead of a single camera. For example, the vehicle C may have multiple cameras 21 surrounding the driver D as appropriate to capture images of the driver D from various angles. The state estimation apparatus 10 may then use the captured images obtained from the cameras 21 to estimate the state of the driver D. The multiple cameras 21 generate images taken at multiple angles, which can be used to estimate the state of the driver D more accurately than with a single camera.

4.9

In the above embodiment, the driver D of the vehicle C is the target person for state estimation. In FIG. 1, the vehicle C is an automobile. In some embodiments, the vehicle C may be of any other type such as a track, a bus, a vessel, a work vehicle, a bullet train, or a train. The target person for state estimation may not be limited to the driver of vehicles, and may be selected as appropriate depending on each embodiment. For example, the target person for state estimation may be a worker at a facility such as a factory, or a care facility resident who receives nursing care. In this case, the camera 21 may be placed to capture an image of the target person to be at a predetermined position.

FIG. 17 is a schematic diagram of a state estimation apparatus 101 used in a system for estimating the state of a worker L at a factory F. The state estimation apparatus 101 has the same structure as the state estimation apparatus 10 according to the above embodiment except that the target person for state estimation is the worker L at the factory F, the state of the worker L is estimated, and the state estimation apparatus 101 is not connected to the automatic driving support apparatus 22. In the present modification, the camera 21 is placed as appropriate to capture an image of the worker L to be at a predetermined work site.

In the same manner as in the above embodiment, the state estimation apparatus 101 (control unit 110) obtains first information about the facial behavior of the worker L based on a captured image (first image) obtained from the camera 21. The state estimation apparatus 101 also obtains second information about the body movement of the worker L based on another image (second image) obtained by lowering the resolution of the image captured by the camera 21. The state estimation apparatus 101 then estimates the state of the worker L based on the first and second information. The state estimation apparatus 101 can estimate, as the state of the worker L, the degree of concentration of the worker L on his or her operation and the health conditions (for example, the worker's physical conditions or fatigue). The state estimation apparatus 101 may also be used at a care facility to estimate an abnormal or other behavior of the care facility resident who receives nursing care.

4.10

In the above embodiment, the captured image includes multiple frames. The control unit 110 analyzes the facial behavior on a frame basis in steps S12 to S14 and the body movement in two or more frames in step S16. However, the captured image may be in any other form and the analysis may be performed differently. For example, the control unit 110 may analyze the body movement in a captured image including a single frame in step S16.

### INDUSTRIAL APPLICABILITY

The state estimation apparatus according to an aspect of the present invention, which estimates various states of a target person more accurately than known apparatuses, can be widely used as an apparatus for estimating such various states of a target person.

### APPENDIX 1

A state estimation apparatus comprising a hardware processor and a memory storing a program executable by the hardware processor, the hardware processor being configured to execute the program to perform:

obtaining a captured image from an imaging device placed to capture an image of a target person to be at a predetermined position;

analyzing a facial behavior of the target person based on the captured image and obtaining first information about the facial behavior of the target person;

analyzing body movement of the target person based on the captured image and obtaining second information about the body movement of the target person; and

estimating a state of the target person based on the first information and the second information.

### APPENDIX 2

A state estimation method, comprising:

obtaining, with a hardware processor, a captured image from an imaging device placed to capture an image of a target person to be at a predetermined position;

analyzing, with the hardware processor, a facial behavior of the target person based on the captured image, and obtaining first information about the facial behavior of the target person;

analyzing, with the hardware processor, body movement of the target person based on the captured image, and obtaining second information about the body movement of the target person; and

estimating, with the hardware processor, a state of the target person based on the first information and the second information.

### REFERENCE SIGNS LIST

10 state estimation apparatus
11 image obtaining unit
12 second analysis unit
13 resolution conversion unit
14 second analysis unit
15 feature vector generation unit
16 weighting unit
17 estimation unit
31 face detector
32 facial component position detector
33 facial component state detector
331 eye opening/closing detector
332 gaze detector
333 face orientation detector
110 control unit
120 storage unit
130 external interface
20 automatic driving system
21 camera
22 automatic driving support apparatus

1. A state estimation apparatus, comprising:
a processor configured with a program to perform operations comprising:
operation as an image obtaining unit configured to obtain a captured image from a camera placed to capture an image of a target person to be at a predetermined position;
operation as a first analysis unit configured to analyze a facial behavior of the target person based on the captured image and obtain first information about the facial behavior of the target person;
operation as a second analysis unit configured to analyze body movement of the target person based on the captured image and obtain second information about the body movement of the target person; and
operation as an estimation unit configured to estimate a state of the target person based on the first information and the second information.

2. The state estimation apparatus according to claim 1, wherein
the first information and the second information are each represented as one or more feature quantities, and
the processor is configured with the program such that operation as the estimation unit comprises operation as the estimation unit that estimates the state of the target person based on the feature quantities.

3. The state estimation apparatus according to claim 2, wherein
the processor is configured with the program to perform operations further comprising operation as a weighting unit configured to determine, for each of the feature quantities, a weight defining a priority among the feature quantities, and
the processor is configured with the program such that operation as the estimation unit comprises operation as the estimation unit that estimates the state of the target person based on each feature quantity weighted using the determined weight.

4. The state estimation apparatus according to claim 3, wherein
the processor is configured with the program such that operation as the weighting unit comprises operation as the weighting unit that determines the weight for each feature quantity based on a past estimation result of the state of the target person.

5. The state estimation apparatus according to claim 1, wherein
the processor is configured with the program to perform operations further comprising operation as a resolution conversion unit configured to lower a resolution of the captured image, and
the processor is configured with the program such that operation as the second analysis unit comprises operation as the second analysis unit that obtains the second information by analyzing the body movement in the captured image with a lower resolution.

6. The state estimation apparatus according to claim 5, wherein
the processor is configured with the program such that operation as the second analysis unit comprises operation as the second analysis unit that obtains, as the second information, a feature quantity associated with at least one item selected from the group consisting of an edge position, an edge strength, and a local frequency component extracted from the captured image with a lower resolution.

7. The state estimation apparatus according to claim 1, wherein
the captured image includes a plurality of frames, and
the processor is configured with the program such that operation as the second analysis unit comprises operation as the second analysis unit that obtains the second information by analyzing the body movement in two or more frames included in the captured image.

8. The state estimation apparatus according to claim 1, wherein
the processor is configured with the program such that operation as the first analysis unit comprises operation as the second analysis unit that performs predetermined image analysis of the captured image to obtain, as the first information, information about at least one item selected from the group consisting of whether a face is detected, a face position, a face orientation, a face movement, a gaze direction, a facial component position, and eye opening or closing of the target person.

9. The state estimation apparatus according to claim 1, wherein
the captured image includes a plurality of frames, and
the processor is configured with the program such that operation as the second analysis unit comprises operation as the second analysis unit that obtains the first information by analyzing the facial behavior in the captured image on a frame basis.

10. The state estimation apparatus according to claim 1, wherein
the target person comprises a driver of a vehicle, and
the processor is configured with the program such that:
operation as the image obtaining unit comprises operation as the image obtaining unit that obtains the captured image from the camera placed to capture an image of the driver in a driver's seat of the vehicle, and
operation as the estimation unit comprises operation as the estimation unit that estimates a state of the driver based on the first information and the second information.

11. The state estimation apparatus according to claim 10, wherein
the processor is configured with the program such that operation as the estimation unit comprises operation as the estimation unit that estimates at least one state of the driver selected from the group consisting of looking forward carefully, feeling drowsy, looking aside, putting on or taking off clothes, operating a phone, leaning, being interrupted in driving by a passenger or a pet, suffering a disease attack, looking back, resting a head on arms, eating and drinking, smoking, feeling dizzy, taking abnormal movement, operating a car navigation system or an audio system, putting on or taking off glasses or sunglasses, and taking a photograph.

12. The state estimation apparatus according to claim 1, wherein
the target person comprises a factory worker, and
the processor is configured with the program to perform operation such that:
operation as the image obtaining unit comprises operation as the image obtaining unit obtaining the captured image from the camera placed to capture an image of the worker to be at a predetermined work site, and
operation as the estimation unit comprises operation as the estimation unit estimating a state of the worker based on the first information and the second information.

13. The state estimation apparatus according to claim 12, wherein
the processor is configured with the program to perform operation such that operation as the estimation unit comprises operation as the estimation unit estimating, as the state of the factory worker, a degree of concentration of the factory worker on an operation or a health condition of the factory worker.

14. A state estimation method implemented by a computer, the method comprising:
obtaining a captured image from an imaging device placed to capture an image of a target person to be at a predetermined position;
analyzing a facial behavior of the target person based on the captured image;
obtaining first information about the facial behavior of the target person by analyzing the facial behavior;
analyzing body movement of the target person based on the captured image;
obtaining second information about the body movement of the target person by analyzing the body movement; and
estimating a state of the target person based on the first information and the second information.

15. A non-transitory computer-readable recording medium storing a state estimation program, which when read and executed, causes a computer to perform operations comprising:
obtaining a captured image from an imaging device placed to capture an image of a target person to be at a predetermined position;
analyzing a facial behavior of the target person based on the captured image;
obtaining first information about the facial behavior of the target person by analyzing the facial behavior;
analyzing body movement of the target person based on the captured image;
obtaining second information about the body movement of the target person by analyzing the body movement; and
estimating a state of the target person based on the first information and the second information.
